(19) United States
(12) Patent Application Publication
(10) Pub. No.: US 2007/0253683 A1
(43) Pub. Date: Nov. 1, 2007

(54) Information recording apparatus

(76) Inventor: Hiroyuki Marumori, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/642,716

(22) Filed: Dec. 21, 2006

(30) Foreign Application Priority Data
Apr. 27, 2006 (JP) 2006-122871

(51) Int. Cl. H04N 5/00

(52) U.S. Cl. 386/125

(57) ABSTRACT

In a medium such as a DVD+RW disk in which recording is performed with cell numbers changed, when a recording operation is performed and stopped repetitively at a short interval like shooting with a video camera, the number of used cells reaches the limit value before a capacity of the medium is completely depleted. In this case, a user is compelled to stop the recording operation. In the present invention, not only a remaining capacity of a medium but also that correlated to the number of remaining cells is computed and displayed during the recording operation. When the number of remaining cells is correlated to a remaining capacity of a medium, a displayed value for the remaining capacity gradually decreases, so that a user is not required to unintentionally stop a recording operation.

### CLAIM OF PRIORITY

The present application claims priority from Japanese application serial no. JP 2006-122871, filed on Apr. 27, 2006, the content of which is hereby incorporated by reference into this application.

### BACKGROUND OF THE INVENTION

(1) Field of the Invention

The present invention relates to a recording apparatus for recording information in a disk or the like, and more specifically to a technique for notifying a remaining recordable capacity.

(2) Description of the Related Art

In the field of recording apparatuses, there are several techniques for notifying a remaining recordable capacity (expressed by, for example, a remaining recording time).

For instance, Japanese Patent Laid-Open Publication No. HEI 11-328937 describes a technique for “computing data for a currently remaining recording capacity based on a current bit rate for compression of an input image and a currently remaining capacity of a recording medium with a remaining recording capacity computing unit and displaying the computed recording capacity data with a displaying unit”.

Japanese Patent Laid-Open Publication No. 2004-318975 describes a technique for “providing a display state for counter information by synchronizing a real time counter displayed on a monitor screen with a remaining recordable capacity so that the user does not have any sense of discomfort.”

### SUMMARY OF THE INVENTION

Recently, there is a tendency for shifting media from tapes to disks to record digital information. In the case of a disk, random access is possible and rewinding is not necessary, which eliminates the possibility of overwriting and makes it easier to search or reproduce recorded information.

DVD is one of typical disks. There are several standards for the DVD including a DVD-RAM allowing for rewriting 100,000 times, a DVD-RW compatible with both of the video recording standard adopted for the DVD-RAM and the video standard adopted for a DVD-ROM, and a DRD-R having high compatibility with the current players, which has been established by the DVD Forum. An organization called DVD+RW Alliance has established DVD+RW and DVD+R.

In the DVD+RM or the DVD+R (sometimes referred to as +system medium hereinafter), by employing the recently developed zero linking technique (which is a function for realizing stable data writing by avoiding Buffer Under RunError which causes data writing to be interrupted since the speed to transfer data to a drive is lower than the data writing speed when data is written in the CD-R media or the like), the compatibility with the existing players is improved. Furthermore, the DVD-RW is based on the video standards for authoring, and enables editing like the DVD-RAM, although the structure is simple. When data is reproduced with an existing player, finalizing is required. However, in the case of +system media, finalizing is automatically performed when data is reproduced from a product. Therefore, a user is not required to perform finalizing each time the user records information, which is convenient for the user.

Although the basic data structure for the DVD+RW complies with the video standards, there are more restrictions as compared to those in the video standards. Although there are restrictions for the VOBS, description is made herein for restrictions for a cell.

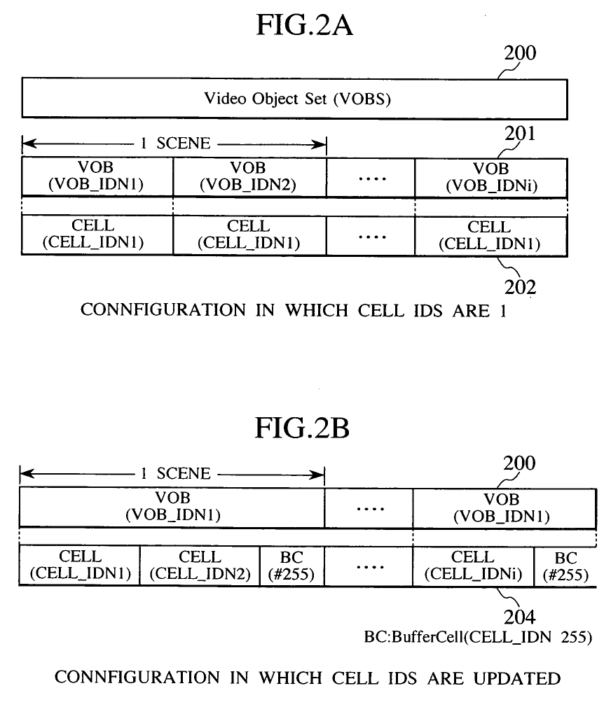

Description is made below of a data structure complied with the VF (DVD video format) with reference to FIGS. 2A and 2B. FIG. 2A illustrates the case where all of CELL_IDs are 1, and FIG. 2B illustrates the case where the CELL_IDs are updated.

First, the entire video and audio data is referred to VOBS (Video Object Set) 200. The VOBS 200 consists of a plurality of VOBs (Video Objects). Reference numeral 201 denotes the VOB. The VOB 201 consists of a plurality of cells. The cell is a minimum data set that is controlled during reproduction. The cell comprises a package of video data, audio data and navigation information. For instance, when data is recorded in the DVD-R according to the video standards, all the CELL_IDs are set to 1 in many cases since the maximum value for the CELL_ID is defined to be 255 in order to avoid the restriction. Reference numeral 202 denotes the CELL_ID. That is, as a data structure complied with the video standards, the data structure shown in FIG. 2A is general.

However, for the DVD+RW complied with the video standards, there is the following regulation for the CELL_ID: “the CELL IDs must not have the same value and are designated with unique values from 1 to 254, and the CELL_ID of a buffer cell indicating the end of the VOB must be 255”. That is, when data is recorded in a medium having the restriction as described above, it is required that cells be generated by updating the CELL_IDs in order not to exceed 255.

As for the VOB_IDN also employed in the VOB, all of the ID numbers are required to be set to 1, and therefore in the case of the DVD-R, the configuration denoted by reference numeral 202 is generally employed. In the case of the DVD-RW, all of the ID numbers are required to be set to 1 as denoted by reference numeral 203.

One cell is generated for every several tens seconds during recording. The time for generation of a cell largely depends on a buffer size in the cell. This is because information data correlating with each other (such as information recorded within a certain period of time in the past and in the future) is stored in the cell and a memory space to store the information data in a buffer is limited. Therefore, in many cases, a cell length is smaller than a buffer size. For instance, when the recording rate is 3 Mbps, the cell time is about 60 seconds, although the time varies according to the products. When information data recorded once is called as “scene”, a cell needs to be closed each time a scene is created since a cell is a minimum unit for reproduction. When recording is performed for every about 10 seconds at the recording rate of 3 Mbps as described above, that is, when scenes for a time period of about 10 seconds are continuously generated, one cell is generated anew for every about 10 seconds. Although the cell time is less than 60 seconds, there is a limit requiring that the maximum number of cells is 254. Therefore, recording is inhibited when all of 254 cells are used for recording information. The subsequent recording is inhibited, because a recording apparatus is required to satisfy the standards.

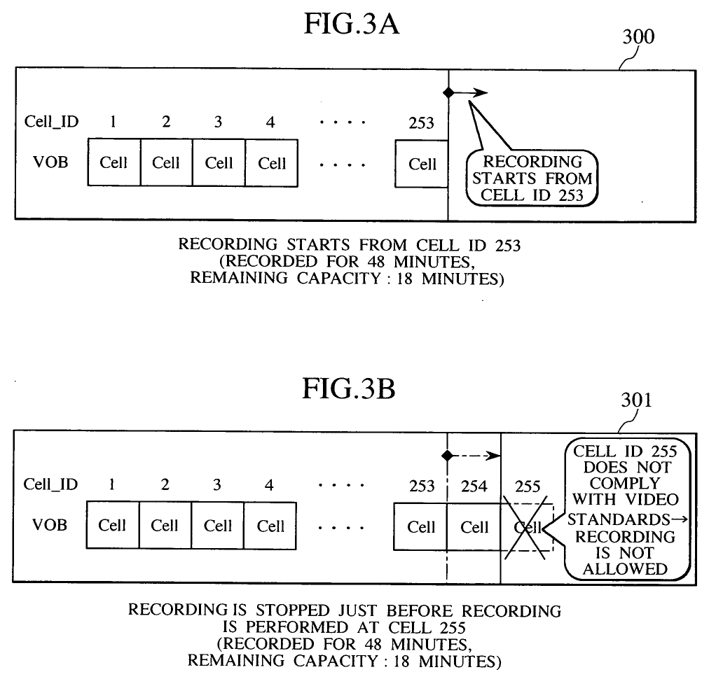

Further detailed descriptions are provided below with reference to FIG. 3. It is assumed herein that the recording rate is 3 Mbps and the cell time is about 60 seconds. FIG. 3A illustrates that recording is started from the state where a VOB consists of 253 cells (10 sec*253 scenes: cell closed at the cell time of 10 seconds). When recording is started in this state, one cell is generated in about 60 seconds. If the state is left as it is, also a cell with the CELL_ID of 255 is prepared, as shown in FIG. 3B. The cell with the CELL_ID of 255 is also referred to as “buffer cell”. Therefore, immediately before the cell with the CELL_ID of 255 is prepared, or when a cell with the CELL_ID of 254 is completed, recording needs to be stopped. In the case shown in FIG. 3, since recording has been performed for about 42 minutes, a remaining recording capacity must be about 18 minutes based on the medium capacity, if calculation is performed like a conventional technique. That is, in the conventional system, although the remaining capacity is expressed as 18 minutes, recording cannot be performed, or the recording is stopped on the way. In this case, although the recordable time still remains, the user cannot perform recording, or recording is stopped at an unexpected point of time, which is inconvenient for the user. Also the user may miss a good chance for taking video because recording is inhibited suddenly.

Also, the invention disclosed in Japanese Patent Laid-Open Publication No. HEI 11-328937 takes into consideration a change in a remaining recordable capacity according to a variable bit rate, but does not take into consideration an upper maximum value for cells or other factors, so that similar problems may occur. In other words, even if the bit rate is kept constant, when a cell with the CELL_ID of 254 is generated, recording may disadvantageously be stopped even though a capacity still remains.

This problem is not limited to cells in the DVD+RW, and also occurs, for instance, in a case where there is a limit not relating to a capacity of a recording area but concerning a configuration unit for the recording area (corresponding to, for instance, a cell).

To solve the problems as described above, the present invention provides a recording apparatus which can notify a user of a remaining recordable capacity based on the number of remaining configuration units in a recording area of a recording medium, or a recording apparatus which can notify a user of the number of remaining configuration units in a recording area of a recording medium and also of a remaining recordable capacity based on a capacity of the recording medium.

The present invention is capable of notifying the user of recordable capacity with high reliability.

Challenges, means, and effects of the present invention other than the above description are described with reference to embodiments of the present invention hereinafter.

### SUMMARY OF THE INVENTION

These and other features, objects and advantages of the present invention will become more apparent from the following description when taken in conjunction with the accompanying drawings wherein:

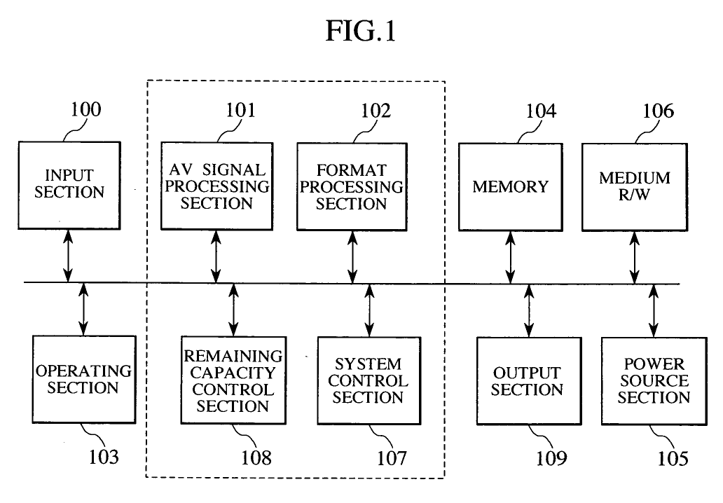

FIG. 1 is a block diagram illustrating an example of a configuration of a recording apparatus according to the present invention;

FIGS. 2A and 2B are views illustrating different data structures in a VOBS;

FIGS. 3A and 3B are views illustrating situations in which recording is stopped because of a limit for cells;

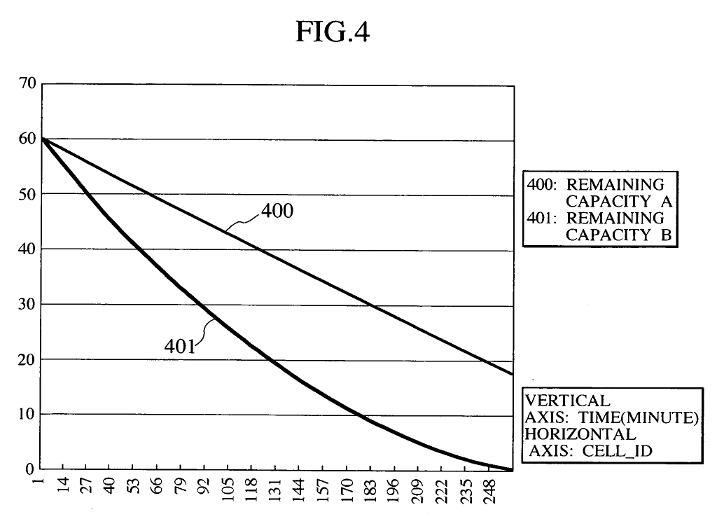

FIG. 4 is a view illustrating a relationship between the number of remaining cells and a remaining recordable time;

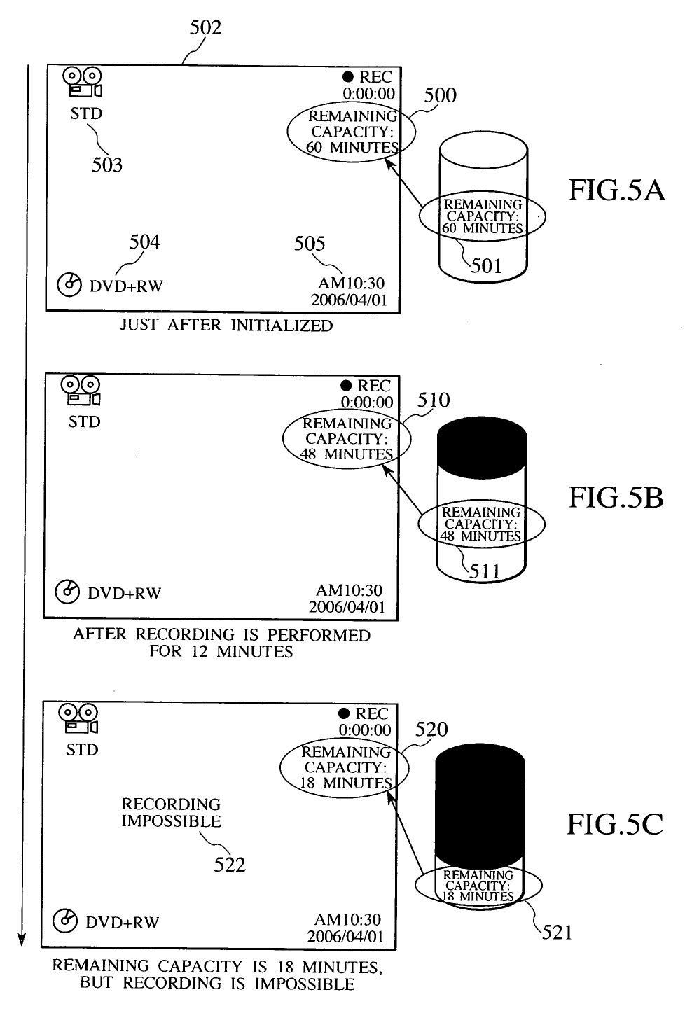

FIGS. 5A to 5C are views illustrating displays of remaining recording capacities without taking consideration into the number of remaining cells;

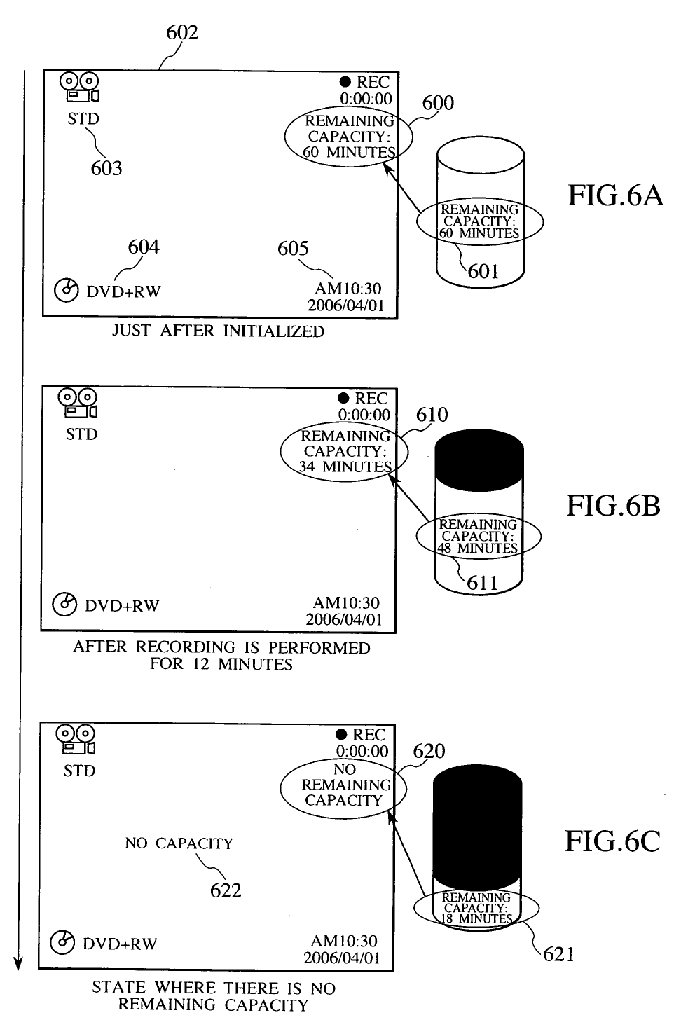

FIGS. 6A to 6C are views illustrating displays of remaining recording capacities with taking consideration into the number of remaining cells; and

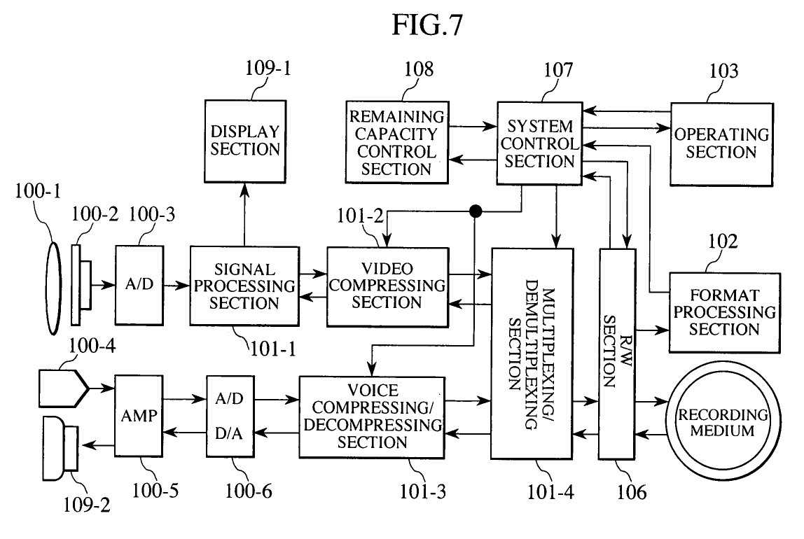

FIG. 7 is a block diagram illustrating a configuration of the recording apparatus.

### DESCRIPTION OF THE PREFERRED EMBODIMENTS

Preferred embodiments of the present invention are described in detail below with reference to the accompanying drawings. In the following description, a video camera compatible with the DVD-RW is taken as an example. It should be noted that the present invention is not limited to the embodiments described below. The present invention is applicable not only to the DVD, but also to the DV or the HD-DVD. Furthermore, the present invention is applicable not only to a camera, but also to an apparatus or a system for recording information in a medium in which there is a limit not relating to a capacity of a recording area but to a configuration unit (such as a cell) of the recording area. A theoretical configuration of a recording area is described above with reference to FIG. 2 and FIG. 3. To supplement the description above, a cell is defined with the VF or the like, and is a basic unit for reproduced contents. One cell consists of a plurality of video object units (VOBU). One cell can be used for different program chains (PGC) in one video title set. The PGC is management information, and includes a list specifying an order of reproduced cells. The term of restrictions as used herein means: an amount of data which can be stored in a configuration unit is varied and limited; the configuration unit needs to be closed for reproduction; unique information (ID) is required to change individually; and the unique information is limited. However, all the above restrictions are not always required. Here, the capacity means an amount of information that can be stored in a medium, for example, which is expressed by a unit such as MB. It should be noted that there is a method in which a remaining recordable capacity is obtained, for instance, by checking a sector address indicating a physical (fixed) region in a recording medium.

### Embodiment 1

FIG. 1 illustrates an example of a configuration of a video camera which can record information in the DVD+RW disk. Reference numeral 100 denotes an input section for inputting video and audio data and includes a lens, a CCD (Charge Coupled Device, which is also referred to as an image pickup device), and a microphone. An A/D converter outputs video and audio data as digital signals. Reference numeral 103 denotes an operating section operated by a user, and includes a record/stop button, a zoom button, and the like. The reference numeral 101 is an AV information processing section. The AV information processing section 101 includes a stream generating function that compresses video and audio data acquired from the input section 100 and generates a video stream and an audio stream from the video and audio data, respectively. Such functions as video signal processing or audio filtering may be incorporated in the AV information processing section 101. Reference numeral 102 denotes a format processing section that identifies the type of a recording medium and generates information satisfying a formatting standard required for the type of a recording medium. The AV information processing section 101 also includes a multiplexing/demultiplexing control function for multiplexing the information generated in the format processing section 102 and the video stream and the audio stream generated in the AV information processing section 101 to generates a program stream which is a combination of video and audio data. When reproducing information recorded in a recording medium, the AV information processing section 101 demultiplexes the video stream and the audio stream from the multiplexed program stream. Reference numeral 104 is a buffer memory in which, for instance, a program stream generated in the AV information processing section 101 is stored. Furthermore, information acquired from a recording medium (such as information concerning a recording start position or a recording capacity) and information concerning the apparatus (such as a power value for an optical pickup described hereinafter) can be stored in the buffer memory 104. Reference numeral 105 denotes a power source section for supplying a power to the video camera. A power may be supplied from a charged battery, and also an AD power may be supplied from a plug socket for utility power. Reference numeral 106 is a reader/writer section (R/W section) for reading data from or writing data in a recording medium, and in this embodiment, the reader/writer section 106 can read data from or write data in a DVD+RW disk. The reader/writer section 106 includes an optical pickup, an actuator, a motor for rotating a recording medium, and a driver. For example, after video information with a certain amount or an amount corresponding to a certain period of time is buffered in the buffer memory 104, the reader/writer section 106 writes the video information in a recording medium by batch processing (intermittent recording) to reduce power consumption in the reader/writer section 106. Reference numeral 108 is a remaining capacity control section for acquiring a remaining capacity from the information read with the reader/writer section 106 and also computing a remaining recordable capacity after checking the number of remaining cells by the format processing section 102. The remaining recording capacity can be acquired not only from the information read from a recording medium, but also from the information stored and updated in the buffer memory 104. Reference numeral 109 denotes an output section for reproducing video and audio data, and includes an LCD (Liquid Crystal Display, which is also referred to as a display unit), and a speaker. Also the remaining recordable capacity computed in the format processing section 102 is displayed on the output section 109. Reference numeral 107 denotes a system control section for controlling the entire video camera. The system control section 107 includes functions for controlling each section (such as an input control function, a recording medium control function, and an output control function). Software included in the AV information processing section 101, format processing section 102, system control section 107, and remaining capacity control section 108 is executed by a microcomputer such as a CPU. However, the functions of the above sections may be executed by hardware thereof.

FIG. 7 illustrates the example of a configuration shown in FIG. 1 with a different expression. Numbers at the back of each hyphen are common to reference numerals for the components shown in FIG. 1, and the details are described above. Reference numeral 100-1 denotes a lens; 100-2, a CCD; 100-3, an A/D converter; 100-4, a microphone; 100-5, an amplifier; and 100-6, an A/D converter (D/A converter). Reference numeral 101-1 denotes a video signal processing section; 101-2, a video compressing/decompressing section; 101-3, an audio compressing/decompressing section; and 101-4, a multiplexing/demultiplexing section. Reference numeral 109-1 denotes a display section, and 109-2 denotes a speaker. The display section may be divided into a display section provided in a finder and a movable display section provided outside a housing for a camera. The buffer memory section 104 is not shown. However, a plurality of memories 104 may be provided, and the memory 104 may be accessed from each of the components shown in FIG. 7. Although the power source section 105 is not shown either, the power source section 105 is controlled by the system control section 107 and supplies a power to each of the components shown in FIG. 7. In FIG. 7, all the circuit lines are not shown, and all the components are connected to each other as shown in FIG. 1.

A description will now be made of management for a remaining recordable capacity.

When the operating section 103 receives an instruction for recording from a user, the system control section 107 starts to acquire video and audio data from the input section 100. The acquired video signal is processed for a camera or the like by the AV information processing section 101 and is compressed in an MPEG 2 (Moving Picture Experts Group 2) to generate a video elementary stream. The acquired audio signal is passed through a filter or the like and is compressed in the AC3 (Audio Code number 3) to generate an audio stream. The compression (encoding) format is not limited in this embodiment. For instance, the format may be MPEG4 or MP3 (MEPG Audio Layer-3).

In the format processing section 102, management information for a format complied with the DVD+RW standards is generated for the video elementary stream and the audio elementary stream generated in the AV information processing section 101 in order to manage CELL IDs. Then a program stream is generated and written in the memory 104. In this step, the information may be managed not only by using information concerning standards, but also by an independent management file. Especially, the format for the DVD+RW disk is based on the standards for the DVD video, and is basically for authoring. Namely, the format is suitable for editorial works for such data as characters, images, audios, and videos. When recording is performed in real time, there are some cases where it is preferable to use not only information concerning standards but also a management file for the recording apparatus or the like. The program stream written in the memory 104 is recorded by the reader/writer section 106.

Processing performed by the remaining capacity control section 108 is described below. A remaining capacity of a disk after recording is acquired from the reader/writer section 106. A remaining recording time is computed (output) based on the current recording rate. The equation used for computing in this step is, for instance, as shown below:

Remaining recordable capacity A=Recording capacity/recording rate

As a specific example, the case is described below in which a remaining recordable time is computed assuming that recording is performed for about 12 minutes at the recording rate of 3 Mpbs. A capacity on a single side of an 8-cm disk used in a camera is about 1.4 GB, but a capacity actually available for recording is about 1.32 GB (this value varies according to products). A capacity required for recording for about 12 minutes at the recording rate of 3 Mpbs is calculated as follows:

(12 min)×(60 sec/min)×(3 Mpbs)/(8 bytes/bit)=about 270 MB

A remaining capacity after recording for 12 minutes is calculated as follows:

(1.32 GB)×(1024 MB/GB)−(270 MB)=1081 MB

### Therefore, the remaining recordable capacity A (remaining recording time A)=(1081 MB)×(8 bytes/bit)/(3 Mbps)/(60 sec/min)=about 48 minutes.

Next, a description is made of processing for correcting the remaining recordable capacity A according to the number of remaining cells.

When acquiring data for a remaining capacity of a disk after recording through the reader/writer section 106, the remaining capacity control section 108 acquires information on cells currently being generated from the format processing section 102. The format processing section 102 is sometimes referred to as “configuration unit information acquiring section”. The information is about CELL_ID. Since the number of cells and the ID value are generally identical, the ID number can be regarded as the current number of cells. The largest value for CELL_ID is defined to be 254, the number of remaining recordable cells can be calculated by subtracting the current number of cells from 254. The number of cells decreases each time recording is performed, and therefore when the number of remaining cells is zero (0) before the capacity is fully consumed, recording needs to be inhibited. That is, when the number of remaining cells is zero (0), it means that the remaining capacity is zero (0). Therefore, in this embodiment, a display of a remaining capacity reflecting both a capacity and the number of remaining cells is provided by multiplying the remaining recordable capacity A by a percentage (ratio) of the number of remaining cells. More specifically, a new display of a remaining capacity is provided as described below:

Remaining recordable capacity B=Remaining recordable capacity A×((254−(the current number of cells))/254)

As a specific example, the case is described in which recording is performed for 12 minutes at the recording rate of 3 Mpbs like in the case described above. However, recording and stop of recording are repeated for every 10 seconds, and the remaining recordable time is calculated after the recording is performed for about 12 minutes. In this case, 72 scenes are recorded and the number of remaining cells is 72 as expressed by the following equation:

(12 minutes)×(60 sec/min)/10 sec=72 scenes

Therefore the remaining recording capacity B is 34 minutes as expressed by the following equation:

Remaining recordable capacity B (Remaining recordable time B)=(48 minutes)×((254−72))/254)=34 minutes

FIGS. 5 and 6 show examples in which the remaining recordable time A and the remaining recordable time B, which have been calculated, are displayed in the output section 109. Reference numerals 502, 602 denote an LCD screen in the output section 109, and an image input through a CCD in the input section is displayed through a camera. Reference numerals 503, 603 illustrate the recording mode, and in this case the recording rate is set to about 3 Mpbs in the STD mode. Reference numerals 504, 604 illustrate the type of a recording medium inserted in a video camera, and in this case, the type of a recording medium is DVD+RW. Although not shown in FIG. 5 and FIG. 6, it is preferable to display a remaining power charged in the power source section 105.

FIG. 5A and FIG. 6A illustrate the state immediately after the initialization is performed and where recording has not been performed. FIG. 5B and FIG. 6B illustrate the state where recording is performed for about 12 minutes by repeating recording and stopping once for every 10 seconds. FIG. 5C and FIG. 6C illustrate the state in which no cell remains.

In FIG. 5A and FIG. 6A, the remaining recordable time is 60 minutes as shown with 501 and 601, and a display for a remaining time shows 60 minutes with 500 and 600. The reference numerals 501 and 601 show a visualized capacity of a disk. However, the visualized capacity may be added to the screen shown in FIG. 5 and FIG. 6, although it is not shown in the figures.

In FIG. 5B and FIG. 6B, a remaining capacity of the disk is an amount corresponding to 48 minutes as shown with 511 and 611. As shown with 510 in FIG. 5B, the remaining time is displayed as 48 minutes. In this embodiment, however, the remaining recordable time B corrected by referring to the number of remaining cells is displayed as the remaining time, and is displayed as 34 minutes as shown with 610. With the processing and the display as shown in FIG. 6, a value displayed for a remaining capacity decreases in association with decrease of a remaining capacity of a disk as well as decrease of the number of remaining cells.

In FIG. 5C and FIG. 6C, although a recordable capacity equivalent to 18 minutes still remains as shown with 521 and 621, there is no remaining cell. In this case, although a display of 18 minutes is provided as shown with 520 in FIG. 5C, recording is not possible. It is preferable to provide a message of, for instance, “now recording impossible” to inform a user that there is no remaining cell and recording is impossible. In FIG. 6C, for instance, a display of zero minute can be provided as shown with 620. Even if a display of no cell is displayed before a capacity of a disk is depleted, the remaining recordable time gradually decreases, and the user can be aware that the recordable capacity is almost depleted when a display for the remaining recordable time of 2 or 3 minutes is provided. In this case, the user will not feel that recording is suddenly disabled. In this embodiment, depletion of a remaining capacity does not always mean that the capacity is completely depleted, but means that the remaining capacity reaches a predetermined value or below.

FIG. 4 shows a difference between the remaining recordable time A (remaining capacity A) not reflecting the number of remaining cells and the remaining recordable time B (remaining capacity B) reflecting the number of remaining cells. Also, FIG. 4 is a view illustrating a relationship between the number of remaining cells and recording time with respect to the difference in methods of computing a remaining capacity. The vertical axis is plotted with a remaining time (minutes) and the horizontal axis with the number of cells. Reference numeral 400 denotes a remaining recordable time A based on a capacity, and reference numeral 401 denotes a remaining recordable time B correlating to the number of remaining cells. The displays correspond to the case in which recording is performed to a DVD+RW disk with a diameter of 8 cm at the recording rate of 3 Mbps by repeating recording and stopping for every 10 seconds.

It can be understood that the remaining capacity A shifts substantially linearly. Also it can be understood that the remaining capacity B decreases faster as compared to the remaining capacity A. In other words, the remaining recordable time is originally displayed as 60 minutes, and when information of the same capacity (for instance, 150 MB) or for the same time (for instance, 10 minutes) is recorded, the remaining capacity A decreases by 10 minutes indicating that the remaining recordable time is 50 minutes, while the remaining capacity B decreases by 20 minutes indicating that the remaining recordable time is 40 minutes. This indicates that the remaining capacity B decreases faster than the remaining capacity A.

The effect that the number of remaining cells is insufficient occurs more frequently when an interval between recording and stopping is short, that is, when recording is performed shortly and frequently. Therefore this effect affects a portable camera used for taking many scenes for a period of time of several seconds to several minutes more as compared with a stationary recorder used for recording a broadcast program for a period of time of several tens minutes.

When the remaining capacity B decreases quickly, a message to inform the fact may be displayed. The message is that, for instance, “Disk can be used more effectively by increasing the time to take video”. As a method of detecting the fact that the remaining capacity decreases quickly, for example, there is a method of detecting, with the system control method 107, that an interval between an instruction for recording and that for stopping recording performed in the operating section 103 is short, or a method of detecting that a ratio of the remaining capacity A to the remaining capacity B or a difference between the two capacities is a predetermined value or more.

The use of the remaining recordable time B provides the advantage that the sequence for stopping recording when the number of remaining cells is zero can be connected to the conventional sequence of stopping recording when the capacity is depleted to zero. In other words, the processing for stopping recording based on the restrictions for the cell standards can be linked to the processing for stopping recording when the remaining capacity is zero, and therefore there is no need for developing a new sequence for stopping recording, so that the operating sequence can be simplified.

### Embodiment 2

In Embodiment 1, the remaining recordable capacity B is obtained by multiplying the remaining recordable capacity A by a percentage (ratio) of the number of remaining cells. However, the remaining recordable capacity B reflecting the number of remaining cells is not limited to the value described above. For instance, an average time of recorded scenes is calculated, and the average time is multiplied by the number of remaining cells to obtain the remaining recordable capacity B. That is, when 100 scenes are taken and the average time of the scenes is 12 seconds, if the number of remaining scenes to be taken is 154, the required recordable time is calculated as about 30 minute by the following expression:

Remaining 154 scenes×12 sec/(60 sec/min)=about 30 minutes

Also in this case, if the remaining recordable capacity A based on a capacity is employed, remaining capacity is displayed as 20 minutes because 12 seconds×100 scenes/(60 sec/min)=20 minutes, and the display indicates that the remaining recordable time is 40 minutes (because 60 minutes−20 minutes=40 minutes). However, the value can be corrected to a shorter value of 30 minutes for display.

### Embodiment 3

In Embodiment 1, only the remaining recordable capacity B is displayed (Refer to FIG. 6). However, information indicating the number of remaining cells may be displayed or used together with the remaining recordable capacity A. Even when information indicating the number of remaining cells is used together with the remaining recordable capacity A, the user can be alerted before recording is disabled due to depletion of cells even though a display indicating a remaining capacity is being provided. As the information indicating the number of remaining cells, the remaining recordable capacity B in Embodiment 1 or Embodiment 2 may be displayed. Also the configuration is allowable in which a value for the number of remaining cells is displayed and counted down, or in which decrease of the remaining cells may be displayed by showing an image such as a circle graph or a bar graph and changing a color of the image to indicate the remaining capacity.

### Embodiment 4

In Embodiment 1, description is made assuming use of one type of a recording medium (such as a DVD+RW disk). However, the recording apparatus (such as a video camera) is compatible with two or more types of recording media. In a recording medium in which change of a cell ID is not required or in which there is no specific limit for the number of cells as shown in FIG. 2A, it is not always required to use the remaining recordable capacity B like in Embodiment 1. When there is no specific limit value for the number of cells, the remaining recording capacity B can not be calculated through the equation in Embodiment 1. In this case, the configuration may adopted in which the type of a recording medium inserted into the format processing section is detected based on information for the recording medium acquired in the reader/writer section 106 and the operating mode is switched between the mode in which the remaining recordable capacity B is used and the mode in which the remaining recordable capacity B is not used based on the detection result. For instance, in the case of the DVD+RW disk, the display is provided by processing as shown in FIG. 6, and in the case of the DVD-RW disk, the display is provided by processing as shown in FIG. 5. Selection of the operating mode is not limited to switching between the mode using the remaining recording capacity B and the mode not using the remaining recording capacity B, and the mode for calculating or displaying the remaining recordable capacity may be switched according to the type of a recording medium.

### Embodiment 5

Furthermore, a display for a remaining recording capacity may be correlated to a remaining quantity of a power charged in the power source section 105 or a remaining capacity in an area in which an independent management file is written. Data for a remaining capacity of a power is detected by acquiring a remaining power in the power source section 105 with the system control section 107. The remaining capacity can be obtained by subtracting the currently used capacity from a capacity prescribed in a memory 104 or the like.

As described in Embodiments 1 to 5 above, in a medium in which a limit is provided for the number of cells each used as a minimum configuration unit, it is necessary to stop recording even though the recording is being performed. In the embodiments, however, a display for the number of remaining cells is correlated to that for a remaining capacity, so that the user almost does not have sense of discomfort such as sudden stop of recording because the displayed remaining capacity naturally decreases. In the case where the remaining capacity gradually decreases to zero, the user can easily expect the stop of recording operation. Even when the number of remaining cells is extremely small, a displayed value for a remaining capacity gradually decreases, so that the user does not have any sense of discomfort caused by unexpected stop of the recording operation.

Although the restrictions for the number of cells are described above in detail, the effect in which recording is disabled even though there still remains a capacity available for recording may occur in relation to a remaining power volume or a limitation for an area for independent management information managed in the cell. Thus, control may be provided based on these factors. Since information concerning specifications can be written only once like in a recordable disk, the independent management information is used when the independent management is necessary. Because the information concerning specifications can be written only once, the information needs to be updated to reflect the newest information each time a scene is recorded. Because of the restrictions, an area for management of the independent management information is defined upon the initialization. Also when a remaining capacity in this area is depleted, recording is disabled.

While we have shown and described several embodiments in accordance with our invention, it should be understood that the disclosed embodiments are susceptible to changes and modifications without departing from the scope of the invention. Therefore, we do not intend to be bound by the details shown and described herein, but intend to cover all such changes and modifications as all within the ambit of the appended claims.

What is claimed is:

1. A recording apparatus for recording information in a medium, the recording apparatus comprising:
a configuration unit information acquiring section which acquires information on a configuration unit of an area in which information is recorded in the medium; and
a remaining capacity control section which outputs a first remaining recordable capacity based on the information on a configuration unit acquired in the configuration unit information acquiring section.

2. The recording apparatus according to claim 1, wherein
the remaining capacity control section outputs the first remaining recordable capacity based on the configuration unit and on a recording capacity of the medium.

3. The recording apparatus according to claim 2 further comprising:
a system control section which controls to stop a recording operation in a medium when the remaining capacity control section determines that the first remaining recordable capacity is below a predetermined amount.

4. The recording apparatus according to claim 2, wherein
the remaining capacity control section outputs the first remaining recordable capacity according to a percentage of the remaining configuration units.

5. The recording apparatus according to claim 2, wherein
the remaining capacity control section outputs the first remaining recordable capacity according to a recorded capacity or a time per configuration unit already used for recording.

6. The recording apparatus according to claim 1, wherein
the remaining capacity control section outputs a second remaining recordable capacity based on a recording capacity of a medium; and
the recording apparatus further includes a display section which displays the first remaining recordable capacity and the second remaining recordable capacity that have been output by the remaining capacity control section.

7. The recording apparatus according to claim 6, wherein
the displaying section displays the first remaining recordable capacity as the number of configuration units not having been used for recording yet, or a ratio of the configuration units not having been used for recording yet.

8. The recording apparatus according to claim 1, wherein
the remaining capacity control section outputs a second remaining recordable capacity based on a recording capacity of a medium; and
the recording apparatus further includes an output section which issues a notification to an operator of the recording apparatus when a ratio of the first remaining recordable capacity relative to the second remaining recordable capacity or a difference between the two types of remaining recordable capacities is a predetermined value or more, the first remaining recordable capacity and the second remaining recordable capacity being output by the remaining capacity control section.

9. The recording apparatus according to claim 1 further comprising:
an input section which is used to input digital video information;
an operating section which is operated to issue an instruction for recording information in a medium and an instruction for stopping the recording operation; and
a medium control section which controls whether to perform or stop the recording operation in a medium in response to an instruction from the operating section;
wherein the medium control section records the digital information input in the input section in a first configuration unit of the configuration units when the operating section receives an instruction for recording, records the digital information in a second configuration unit when a volume of the digital information is larger than a capacity of the first configuration unit, stops the recording operation in the second configuration unit when the operating section receives an instruction for stopping the recording operation, and records the digital information in a third configuration unit when the operating section again receives an instruction for recording.

10. The recording apparatus according to claim 1, wherein
the first remaining recordable capacity is defined as a remaining recordable time.

11. The recording apparatus according to claim 1, wherein
the configuration units each have a unique ID information; and
the number of configuration units is limited.

12. The recording apparatus according to claim 1, wherein
the configuration unit is a cell included in a video object.

13. A recording apparatus which records information in a medium, the recording apparatus comprising:
a medium control section which controls whether to perform or stop an operation for recording information in the medium and; and
a remaining capacity control section which outputs a remaining recordable capacity of the medium,
wherein, in an output for the remaining recordable capacity from the remaining capacity control section, as compared with a reduction rate of the remaining recordable capacity when recording and stopping are repetitively performed at a first interval by the medium control section, a reduction rate of the remaining recordable capacity is larger when recording and stopping are repetitively performed at a second interval shorter than the first interval.

14. The recording apparatus according to claim 13 further comprising:
an output section which outputs a notification to an operator of the recording apparatus when an interval between an operation for recording information in a medium and an operation for stopping the recording operation is shorter than a predetermined value.

15. The recording apparatus according to claim 13 furthermore comprising:
an optical device which receives an optical image in the form of a video signal; and
a microphone which receives audio in the form of an audio signal.

16. A recording apparatus which records information in a medium, the recording apparatus comprising:
a medium control section which acquires information on the type of the recording medium; and
a remaining capacity control section which switches a mode for displaying a remaining recordable capacity of the medium in response to the information on the type of the recording medium acquired in the medium control section.

17. The recording apparatus according to claim 16, wherein
the remaining capacity control section performs switching between the mode in which a remaining recordable capacity is output based on a configuration unit of a recording area of a medium and a mode in which a remaining recordable capacity not based on the configuration unit is output.

18. A video camera which records a video image, the video camera comprising:
an image pickup section which receives information on a video image;
a read/write section which reads data from or writes data in a DVD+RW or DVD+R disk; and
an output section which outputs a remaining recordable capacity based on the number of cells in the DVD+RW or DVD+R disk acquired in the read/write section.

19. A recording apparatus which records information in a medium, the recording apparatus comprising:
an input section which receives video and audio information;
a medium control section which reads or writes the video and audio information received in the input section from or in the medium inserted in the recording apparatus;
a storing section which stores management information on the video and audio information input in the input section;
a power source section which supplies a charged power; and
a remaining capacity control section which outputs a remaining recordable capacity based on at least one of a capacity of a medium, a quantity of configuration units in a recording area of the medium, an amount of the management information stored in the storage section, and an amount of a power charged in the power source section.
